(19) United States
(12) Patent Application Publication
(10) Pub. No.: US 2021/0387538 A1
(43) Pub. Date: Dec. 16, 2021

(54) FLOOD AVOIDANCE ELECTRIC VEHICLE (EV) CHARGING STATION

(71) Applicant: BEAM GLOBAL, San Diego, CA (US)

(72) Inventor: Desmond Wheatley, Rancho Santa Fe, CA (US)

(21) Appl. No.: 16/898,097

(22) Filed: Jun. 10, 2020

(51) Int. Cl. B60L 53/31; B60L 53/51; H02S 20/32

(52) U.S. Cl. CPC B60L 53/31; H02S 20/32; B60L 53/51

(57) ABSTRACT

A charging station for electric vehicles includes a solar array for converting solar energy into electricity. A curved column is provided for holding the solar array at an upper end of the column. Its lower end is affixed to a platform for stability. An equipment enclosure is attached to the upper end of the curved column for holding electronic and mechanical components that, respectively, collect and store solar energy from the solar array and operationally move the solar array for this purpose. Additionally, a control unit is included with the electronic and mechanical components in the equipment enclosure to monitor vehicle charging operations. For protective purposes, the equipment enclosure is located on the curved column at an elevated height above the stability platform, to prevent flood damage and avoid theft or vandalism.

### FIELD OF THE INVENTION

The present invention pertains to systems and methods for charging electric vehicles (EV) using solar energy. In particular, the present invention pertains to a transportable charging station for electric vehicles that operationally orients a solar array independently from the site-specific requirements for positioning a stability platform on which the solar array is mounted. Further, the present invention is usable as an electric vehicle charging station where the electronic and mechanical components for controlling movements of a solar array, and for storing and processing the energy generated by the solar array, are held in an equipment enclosure at an elevated height adjacent to the solar array, to prevent flood damage and avoid theft or vandalism.

### BACKGROUND OF THE INVENTION

Several practical considerations need to be addressed for the deployment and set up of a relatively large solar panel to generate renewable energy for a transportable electric vehicle (EV) charging station. An obviously important consideration is how to transition the EV charging station between an operational configuration for the solar array and a more compact configuration that is suitable for transporting the charging station. Additional considerations involve site selection for the EV charging station and site-specific requirements for positioning the charging station. It is also important to establish the most efficient orientation for the solar array at the site, in order to optimize its operation.

At an operational site, protection for the EV charging station when it is unattended raises other important considerations. These include an assessment of climatic conditions at the site (e.g. wind forecasts and flood predictions). It is also important to provide anti-theft and anti-vandalism features for the charging station.

With the above considerations in mind, it is an object of the present invention to provide a transportable EV charging station that generates and stores all of its own electricity and is designed to protect its operating components from theft, vandalism and adverse weather conditions, by locating them at an elevated height on the charging station. It is another object of the present invention to provide an EV charging station that can be positioned, as necessary, at a selected site to optimize an operation of the charging station. Still another object of the present invention is to provide a transportable EV charging station that is designed to protect its vulnerable operational components, is easy to manufacture and is simple to deploy.

### SUMMARY OF THE INVENTION

In accordance with the present invention, a charging station for an electric vehicle (EV) includes a solar array having a plurality of solar panels with photovoltaic cells for converting solar energy into electricity. Also included is a curved column which has an upper end and a lower end for supporting the solar array. The lower end of the curved column is attached to a stability platform that defines a horizontal reference line for the charging station, and the solar array is attached to the upper end of the curved column. Additionally, at least one charger is provided for connecting the charging station with an electric vehicle to charge the vehicle.

In detail, the solar array defines a longitudinal center line, and it preferably includes two rows of solar panels which are aligned on opposite sides of the longitudinal center line. Further, each row of solar panels is divided lengthwise into three sections. In this combination, solar panels in one row are joined with corresponding solar panels across the longitudinal center line to create a section. Thus, three contiguous, side-by-side sections are created that include a first side section, a center section and a second side section. In this combination, each section straddles the longitudinal center line of the solar array.

When attached with the stability platform, the curved column is oriented coplanar with the horizontal reference line of the stability platform. Also, the upper end of the curved column is positioned at a vertical height h above a projection point on the horizontal reference line. Further, there will be a distance d along the center line from the lower end of the curved column. Preferably, the vertical height h is greater than 9.5 ft and the horizontal distance d is greater than 5 ft.

An equipment enclosure is attached between the upper end of the curved column and the solar panel. Further, the equipment enclosure is centered on the solar array at the upper end of the curved column. The purpose of the equipment enclosure is two-fold. For one, the purpose of the equipment enclosure is to hold and protect electronic and mechanical components of the charging station that are used to effectively control an operation of the solar panel and to store and condition the electricity generated by the solar panel. For the other, the purpose of the equipment enclosure is to elevate the electronic and mechanical components of the charging station to a height above the stability platform where the components will avoid flood waters, theft or vandalism.

Additional components of the present invention that are held in the equipment enclosure include a storage battery that is connected with the solar array to collect and store electricity from the solar panel. A control unit is also held in the equipment enclosure. Specifically, the control unit is connected with the storage battery and with the charger(s) for monitoring the status of the storage battery and the operation of the charger(s). This monitoring includes recording the time duration and the quantity of electricity that is transferred from the storage battery or the solar panel for use in charging electric vehicles.

An important mechanical component of the present invention is an electronically driven tracking mechanism for operationally moving the solar array in accordance with a predetermined, preprogrammed protocol. For the purpose of describing these movements of the solar array, the upper end of the curved column defines a vertical axis. With reference to this vertical axis, the tracking mechanism establishes a base angle, θ_{base}, for the solar array.

During a setup of the charging station, the base angle θ_{base} can be established anywhere within a horizontal arc that is greater than ±90° from the horizontal reference line of the stability platform. Thus, the solar array can be operationally oriented independently of the orientation of the stability platform. Then, once the base angle θ_{base} has been established, the solar array can be moved horizontally around the vertical axis through angles ±θ that are measured from the base angle θ_{base}. Additionally, the tracking mechanism will also coordinate horizontal movements of the solar array with vertical movements along a vertical arc through an elevation angle ϕ. Thus, by coordinating θ and ϕ in accordance with the predetermined protocol during daylight hours, the solar array is moved so that sunlight will always be incident normal to the plane of the solar panel.

In addition to the tracking mechanism, the equipment enclosure will also include a stowing mechanism. The specific purpose of the stowing mechanism is to reconfigure the solar array between an operational configuration wherein the solar array is moved by the tracking mechanism to generate electrical energy, and a stowed configuration wherein the solar array is prepared for transport.

For an operation of the stowing mechanism, there are essentially two preparatory tasks that need to be accomplished before the solar array is lowered onto the stability platform for transport. The first is to rotate the solar array so that the center line of the solar array is perpendicular to the reference line of the stability platform. The second is to position the solar array in a generally horizontal plane. Thereafter, the horizontal orientation of the solar array will be maintained as the curved column is articulated to lower the solar panel toward the stability platform.

An articulation of the curved column for lowering the solar array onto the stability platform is accomplished by simultaneously performing two counter-rotations. The first is a rotation of the solar array to maintain the solar array in a horizontal plane as it is being lowered. And the second is a rotation of the curved column to lower the upper end of the curved column onto the stability platform. In detail, for this counter rotating operation, the solar array is rotated through an angle β that is measured around a horizontal axis, perpendicular to the curved column, at the upper end of the curved column. On the other hand, the curved column is rotated through an angle α that is measured around a horizontal axis, perpendicular to the curved column, at the lower end of the curved column.

After the upper end of the curved column has been lowered onto the stability platform, the sections of the solar array are folded around the equipment enclosure for transport. Specifically, the first side section is rotated from the center solar section into a vertical orientation on the stability platform and folded around the equipment enclosure. Similarly, the second side section is rotated from the center solar section into a vertical orientation on the stability platform and folded around the equipment enclosure for transport of the charging station. The charging station is then secured and is prepared for transport.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of an electric vehicle (EV) charging station in accordance with the present invention;

FIG. 2 is a schematic presentation of electrical and mechanical components for operating and reconfiguring the charging station;

FIG. 3 is a side elevation view of the charging station;

FIG. 4 is a top plan view of a solar array for the charging station of the present invention;

FIG. 5 is a side view of the charging station shown in FIG. 3 when the charging station has been reconfigured for transport; and

FIG. 6 is an elevation view of the charging station when configured for transport as seen in the direction indicated by arrow 6 in FIG. 5.

### DESCRIPTION OF THE PREFERRED EMBODIMENTS

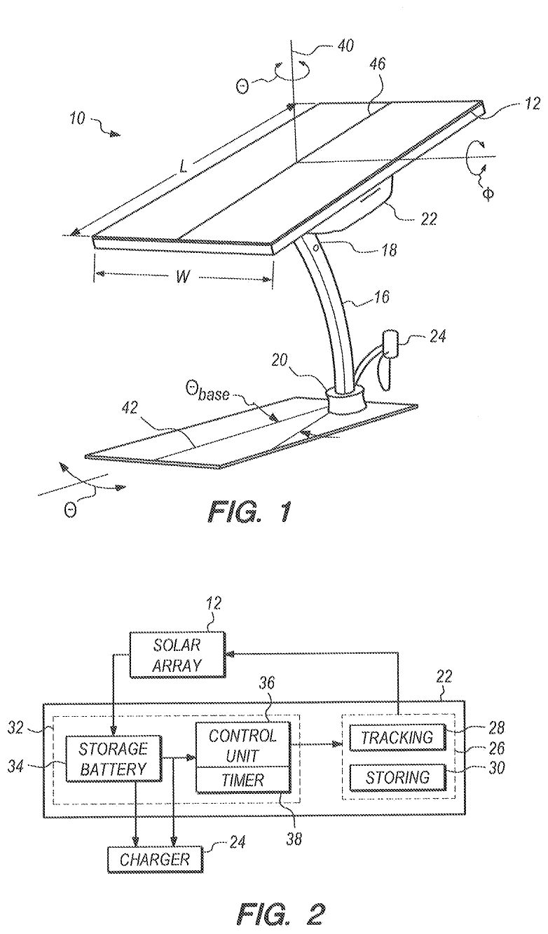

Referring initially to FIG. 1, a charging station in accordance with the present invention is shown and is generally designated 10. As shown, the charging station 10 includes a solar array 12 which is mounted on a stability platform 14. More specifically, the charging station 10 includes a curved column 16 which has an upper end 18 and a lower end 20. Further, the lower end 20 of the curved column 16 is positioned on the stability platform 14 and an equipment enclosure 22 is attached to the upper end 18 of the curved column 16. As shown in FIG. 1, the equipment enclosure 22 and the upper end 18, in combination, are attached to the solar array 12. Also shown in FIG. 1 is a charger 24 that is adapted to connect with an electric vehicle EV (not shown) for the purpose of charging the electric vehicle. It is to be appreciated that although only one charger 24 is shown, the present invention envisions a plurality of chargers 24 can be incorporated into the charging station 10.

With reference to FIG. 2 it will be seen that the equipment enclosure 22 holds mechanical components 26 that include a tracking mechanism 28 and a stowing mechanism 30. Also held in the equipment enclosure 22 are electrical components 32 that include a storage battery 34, a control unit 36 and a timer 38. In combination, the mechanical components 26 and the electrical components 32 control the operation of the charging station 10 and its reconfiguration for transportability.

Operationally, FIG. 2 shows that energy generated by the solar array 12 is sent to the storage battery 34. An electric vehicle can then connect with the charger 24 to receive electricity from the storage battery 34. Also, the control unit 36 receives electricity from the storage battery 34 for the purpose of operating the tracking mechanism 28 and the stowing mechanism 30. FIG. 2 also shows that the control unit 36 interacts with the timer 38 and the charger 24 to monitor and record a charging operation as it is conducted by the charger 24.

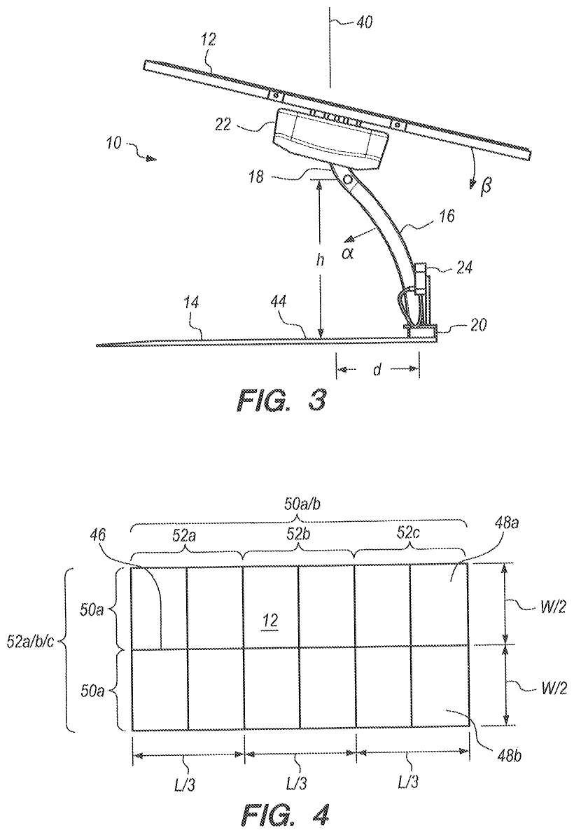

FIG. 3 shows some geometric features of the charging station 10 that are operationally important. Specifically, with the stability platform 14 horizontally oriented, a vertical axis 40 is established at the center of the solar array 12 which passes through the upper end 18 of the curved column 16 and intersects a horizontal reference line 42 on the stability platform 12 (see FIG. 1). In further detail, the horizontal reference line 42 will be perpendicular to the vertical axis 40, and it will be generally coplanar with the curved column 16. Within this geometry, two dimensions are particularly noteworthy when the charging station 10 is configured for its operation (see FIGS. 1 and 3). One is the distance h between the upper end 18 of the curved column 16 and a projection point 44 of the upper end 18 on the reference line 42 where the vertical axis 40 intersects the reference line 42. The other is the distance d of the projection point 44 from the lower end 20 along the reference line 42.

Still referring to FIG. 3, it is to be appreciated that, in response to input from the tracking mechanism 28, the curved column 16 can be rotated through an angle α around an axis (not shown) at the lower end 20 of the curved column 16, that is perpendicular to the plane that includes the curved column 16 and the reference line 42. Simultaneously, also in response to input from the tracking mechanism 28, the solar array 12 can be rotated through an angle β around an axis (not shown) at the upper end 18 of the curved column 16, that is perpendicular to the plane of the curved column 16 and the reference line 42.

The importance of angles α and β is that the tracking mechanism 28 will control changes in these angles to reconfigure the charging station 10 into, and out of, the operational configuration shown in FIGS. 1 and 3, as required, for transport, relocation and setup of the charging station 10. For example, with reference to FIG. 3, a counter-clockwise rotation of the curved column 16 through the angle α in the direction shown, must be coordinated with a clockwise rotation of the solar array 12 through the angle β in the direction shown. Appropriate changes in the angles α and β are needed to reconfigure the charging station 10 into a transport configuration while maintaining the solar array 12 substantially horizontal.

FIG. 4 shows that the solar array 12 defines a longitudinal center line 46 and includes a plurality of different solar panels 48 which are arranged in rows 50 and sections 52. For the disclosure of the present invention, the solar panels 48a and 48b are only exemplary. Further, for disclosure purposes only, FIG. 4 indicates that the longitudinal center line 46 divides the solar array 12 into two rows 50a and 50b of solar panels 48, wherein the rows 50a and 50b are on opposite sides of the longitudinal center line 46. Thus, as shown, the exemplary solar panels 48a and 48b respectively will be in parallel rows 50a and 50b. Moreover, each row 50a and 50b will have a length L and a width W/2.

Still referring to FIG. 4, it will be seen that the solar array 12 is divided into three sections 52a-c. Thus, in this example, it will be appreciated that the solar panels 48a and 48b are in the same section 52c. Further, for these three sections 52a-c, each section will have a width equal to L/3 and a length equal to W. As disclosed below, the solar array 12 will include a first side section 52a, a center section 52b and a second side section 52c. It will be appreciated that the above disclosure is exemplary, that the number of rows 50 and sections 52 may differ, and that they may be arranged as desired to accommodate operational requirements.

For an operation of the charging station 10, the tracking mechanism 28 is used to move the solar array 12 in a manner that orients the solar array 12 so sunlight will be incident thereon substantially normal to the plane of the solar array 12. To do this, the solar array 12 is moved by the tracking mechanism 28 through an azimuthal angle θ and an elevation angle ϕ (see FIG. 1). These coordinated movements are made in accordance with a predetermined protocol. In detail, the operational parameters followed by the protocol will depend on the latitude where the charging station 10 is positioned and the time of day, to include sunrise and sunset. Further, as indicated above, the protocol followed by the tracking mechanism 28 will operate azimuthally relative to θ_{base}, which is determined by the orientation of reference line 42 on the stability platform 14 that is required for installation of the charging station 10.

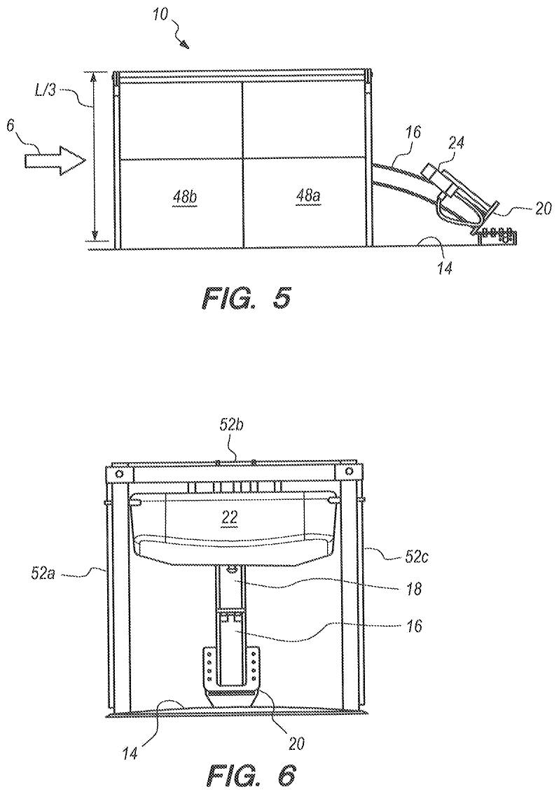

An operation of the stowing mechanism 30 for charging station 10 will be best appreciated with reference to FIG. 3, together with references to FIGS. 5 and 6. Consider first, the reconfiguration of the charging station 10 from an operational configuration as shown in FIG. 3 to a transport configuration as shown in FIG. 5. For this reconfiguration, it is first necessary to move the solar panel 12 so that the longitudinal center line 46 of the solar panel 12 is perpendicular with the reference line 42 on the stability platform 14. The curved column 16 can then be rotated at the lower end 20 of the solar array 12 through an angle α, to thereby lower the upper end 18 of the solar array 12 toward the stability platform 14. Simultaneously, the plane of the solar array 12 is maintained in a horizontal orientation by rotating the solar array 12 about the upper end 18 of the solar array 12.

Once the solar array 12 is at a height of approximately L/3 above the stability platform 14, as shown in FIG. 5, the side sections 52a and 52c can be lowered as shown in FIG. 6, while the center section 52b remains stationary. When the side sections 52a and 52c are positioned as shown in FIG. 6, the charging station 10 has been configured for transport. A reverse sequence of steps can be followed to move the solar array 12 from its transport configuration to its operational configuration.

While the particular Flood Avoidance Electric Vehicle (EV) Charging Station as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A charging station for an electric vehicle which comprises:
a solar array having a plurality of solar panels with photovoltaic cells for converting solar energy into electricity wherein the solar array is rectangular with a length L and a width W and defines a longitudinal center line;
a curved column having an upper end and a lower end;
a stability platform defining a horizontal reference line, wherein the lower end of the curved column is affixed to the stability platform to orient the curved column coplanar with the horizontal reference line and to position the upper end of the curved column at a vertical height h above a projection point on the horizontal reference line, wherein the projection point is at a horizontal distance d on the horizontal reference line from the lower end of the curved column, and wherein the solar array is mounted on the upper end of the curved column;
an equipment enclosure attached between the upper end of the curved column and the solar array for holding electronic components and mechanical components therein, wherein the electronic components and mechanical components are individually connected with the solar array; and
a charger located on the curved column, wherein the charger is connected with electronic components in the equipment enclosure for use in charging electric vehicles.

2. The charging station of claim 1 wherein the electronic components include a storage battery connected to the solar array and a control unit connected between the storage battery and the charger.

3. The charging station of claim 2 wherein the control unit monitors the status of the storage battery and the operation of the charger, to include recording the time duration and the quantity of electricity transferred during a charging operation.

4. The charging station of claim 1 wherein the mechanical components comprise:
a tracking mechanism for operationally moving the solar array to optimize the incidence of sunlight on the solar array; and
a stowing mechanism for reconfiguring the solar array for transport.

5. The charging station of claim 4 wherein the tracking mechanism moves the solar array along a horizontal arc through an azimuthal angle θ, and along a vertical arc through an elevation angle ϕ in accordance with a preprogrammed protocol.

6. The charging station of claim 4 wherein the stowing mechanism establishes the solar panel in a horizontal orientation during an articulation of the curved column when preparing the charging station for transport to a different location.

7. The charging station of claim 1 wherein the upper end of the curved column defines a vertical axis and the charging station further comprises a tracking mechanism held in the equipment enclosure for establishing a base angle θ_{base} for the solar array measured within a horizontal arc greater than ±90° from the horizontal reference line of the stability platform and for moving the solar array around the vertical axis through angles ±θ from the base angle θ_{base} to optimize the incidence of sunlight on the solar array.

8. The charging station of claim 7 wherein the solar array defines a longitudinal center line and includes two rows of solar panels aligned on opposite sides of the longitudinal center line, wherein each row is divided lengthwise into thirds and wherein solar panels in each third of one row are joined, in combination, with solar panels in a corresponding third of solar panels in the row across the longitudinal center line therefrom to respectively create a first side solar section, a center solar section and a second side solar section, the charging station further comprising:
a stowing mechanism held in the equipment enclosure for aligning the longitudinal center line of the solar array perpendicular to the horizontal reference line of the stability platform and for orienting the solar array in a horizontal plane while the solar array is lowered onto the stability platform; and
a means for articulating the curved column to lower the upper end of the curved column onto the stability platform where the first side solar section and the second side solar section can be rotated from the center solar section and folded around the equipment enclosure for transport of the charging station.

9. The charging station of claim 1 wherein the vertical height h is greater than 9.5 ft and the horizontal distance d is greater than 5 ft, to hold the equipment enclosure at an elevated height, to prevent flood damage and avoid theft or vandalism.

10. The charging station of claim 1 further comprising a plurality of chargers.

11. A method for manufacturing an electric vehicle charging station which comprises the steps of:
providing a solar array having a plurality of solar panels with photovoltaic cells for converting solar energy into electricity wherein the solar array is rectangular with a length L and a width W;
affixing a lower end of a curved column to a stability platform to orient the curved column coplanar with a horizontal reference line of the stability platform;
positioning an upper end of the curved column at a vertical height h above a projection point on the horizontal reference line, wherein the projection point is at a horizontal distance d on the horizontal reference line from the lower end of the curved column;
mounting a solar array on the upper end of the curved column;
attaching an equipment enclosure between the upper end of the curved column and the solar array for holding electronic and mechanical components therein, wherein the electronic components and the mechanical components are individually connected with the solar array; and
locating at least one charger with the station, wherein the charger is connected with electronic components in the equipment enclosure for use in charging electric vehicles.

12. The method of claim 11 further comprising the steps of:
connecting a storage battery to the solar array; and
connecting a control unit between the storage battery and the charger.

13. The method of claim 12 further comprising the steps of:
providing a meter to monitor the status of the storage battery and the operation of the charger; and
providing a timer to record the time duration and the quantity of electricity transferred during a charging operation.

14. The method of claim 11 further comprising the steps of:
providing a tracking mechanism to operationally move the solar array to optimize the incidence of sunlight on the solar array; and
providing a stowing mechanism to reconfigure the solar array for transport.

15. The method of claim 14 wherein the solar array is moved along a horizontal arc through an azimuthal angle θ, and the horizontal movement is coordinated with a movement of the solar array along a vertical arc through an elevation angle ϕ in accordance with a preprogrammed protocol.

16. The method of claim 15 further comprising the steps of:
assembling the solar panels of the solar array in a rectangular configuration, wherein the solar array defines a longitudinal center line and includes two rows of solar panels aligned on opposite sides of the longitudinal center line, wherein each row is divided lengthwise into thirds and wherein solar panels in each third of one row are joined, in combination, with solar panels in a corresponding third of solar panels in the row across the longitudinal center line therefrom to respectively create a first side solar section, a center solar section and a second side solar section; and
attaching the equipment enclosure to the center of the solar array.

17. The method of claim 16 wherein the upper end of the curved column defines a vertical axis and the method further comprises the steps of:
connecting the tracking mechanism held in the equipment enclosure with the solar array to establish a base angle θ_{base} for the solar array measured between the longitudinal center line of the solar array and the horizontal reference line of the stability platform and for moving the solar array within a horizontal arc around a vertical axis defined by the upper end of the curved column from the horizontal reference line of the stability platform and for moving the solar array around the vertical axis through angles ±θ greater than ±90° from the base angle θ_{base} to optimize the incidence of sunlight on the solar array; and
connecting the stowing mechanism held in the equipment enclosure with the solar array for aligning the length L of the equipment enclosure with the horizontal reference line of the stability platform while maintaining the solar array in a horizontal plane as the curved column is articulated to lower the upper end of the curved column onto the stability platform and for rotating the solar array to realign the center line of the solar array perpendicular to the horizontal reference line of the stability platform to orient the solar array for rotating the first side solar section and the second side solar section from the center solar section to be folded around the equipment enclosure for transport of the charging station.

18. The charging station of claim 11 wherein the vertical height h is greater than 9.5 ft and the horizontal distance d is greater than 5 ft to hold the equipment enclosure at an elevated height, to prevent flood damage and avoid theft or vandalism.

19. A charging station for an electric vehicle which comprises:
a solar array having a plurality of solar panels with photovoltaic cells for converting solar energy into electricity, wherein the solar array defines a longitudinal center line;
a curved column having an upper end and a lower end;
a stability platform defining a horizontal reference line, wherein the lower end of the curved column is affixed to the stability platform to orient the curved column coplanar with the horizontal reference line and to position the upper end of the curved column at a vertical height h above a projection point on the horizontal reference line, wherein the projection point is at a distance d on the reference line from the lower end of the curved column, and wherein the solar array is mounted on the upper end of the curved column;
an equipment enclosure attached to the upper end of the curved column for holding electronic components and mechanical components therein;
a tracking mechanism held in the equipment enclosure for operationally moving the solar array to optimize the incidence of sunlight on the solar array, wherein the tracking mechanism moves the solar array along a horizontal arc through an azimuthal angle θ around the vertical axis, and along a vertical arc through an elevation angle ϕ around a horizontal axis in accordance with a preprogrammed protocol;
a stowing mechanism held in the equipment enclosure for reconfiguring the solar array for transport, wherein the stowing mechanism establishes the solar panel in a horizontal orientation during an articulation of the curved column when preparing the charging station for transport to a different location;
a storage battery held in the equipment enclosure and connected with the solar array to collect and store electricity from the solar panel;
a charger located on the curved column; and
a control unit held in the equipment enclosure and connected with the storage battery and the charger for monitoring the status of the storage battery and the operation of the charger, to include recording the time duration and the quantity of electricity transferred from the storage battery for use in charging electric vehicles.

20. The charging station of claim 19 wherein the tracking mechanism establishes a base angle θ_{base} for the solar array measured between the longitudinal center line of the solar array and the horizontal reference line of the stability platform, for moving the solar array within a horizontal arc around the vertical axis through angles ±θ greater than ±90° from the base angle θ_{base}, and wherein the vertical height h is greater than 9.5 ft and the horizontal distance d is greater than 5 ft to hold the equipment enclosure at an elevated height, to prevent flood damage and avoid theft or vandalism.
